(19) United States
(12) Patent Application Publication
(10) Pub. No.: US 2015/0136639 A1
(43) Pub. Date: May 21, 2015

(54) UNITARY PACKAGING FOR ONE CONTAINER FILLED WITH A LIQUID PHARMACEUTICAL PRODUCT

(71) Applicant: Andres Marcelo Aranda Lopez, Tlalpan (MX)

(72) Inventor: Andres Marcelo Aranda Lopez, Tlalpan (MX)

(73) Assignee: SANOFI, Paris (FR)

(21) Appl. No.: 14/401,443

(22) PCT Filed: May 21, 2012
(86) PCT No.: PCT/IB2012/001171

§ 371 Date: Nov. 14, 2014

(51) Int. Cl. B65D 1/09; B65D 85/00; A61J 1/06; B65D 83/00

(52) U.S. Cl. CPC B65D 1/09; B65D 83/0055; B65D 85/70; A61J 1/065
USPC 206/530; 53/473

(57) ABSTRACT

The invention provides a packaging for a container (2) filled with a liquid pharmaceutical product and comprising a head (4) and a body (3) both made from a single piece and a neck portion (5) configured to form a frangible junction (6) between said head (4) and said body (3), said packaging (11) being made from plastic material and comprising two layers (12, 13) between which is defined a cavity (18) configured to receive said container (2); wherein said packaging (11) is a unitary packaging which is configured to receive one container (2) and comprises a foldable portion (24) configured so that an upper portion (32) of said packaging (11) which is configured to receive said head (4) of said container (2) folds when said head (4) is submitted to a determined load, an access portion (27) provided at least around a part of said upper portion (32) and being remote to said foldable portion (24) and a protective portion (28) configured between said access portion (27) and said foldable portion (24); so that when said head (4) of said container (2) is broken due to said determined load, said foldable portion (24) is configured to be folded, said access portion (27) is configured to give free access to said liquid pharmaceutical product in said body (3) and said protective portion (28) is configured to protect the access to the broken neck portion (5) of said container.

### FIELD OF THE INVENTION

The invention relates to packaging for containers having liquid pharmaceutical products such as vials, in particular ampoule vials.

The invention further relates to unitary assemblies comprising such packaging and such containers and to a method for opening such unitary assemblies.

### BACKGROUND ART

It is well known that ampoule vials of the self-breakable type are made from glass and comprise a body filled with a liquid pharmaceutical product, a head and a pre-breaking line at a junction between the head and the body.

The head of the ampoule vial requires to be manually broken from the body of said ampoule vial. The break is located to the pre-breaking line in the vicinity of the junction.

A user (for instance a patient) which would break the head of said ampoule vial has to be very careful because, when the head is broken, the ampoule vial comprises sharp edges at the junction between said head and said body. These sharp edges are very dangerous for the user which may injure himself when grasping the broken ampoule vial.

The user can wear gloves to be protected but it is not very convenient.

The U.S. Pat. No. 5,379,898 describes a self-breakable ampoule vial having a neck zone on which is provided a pre-breaking line. The neck zone is covered by a sleeve of plastic material which is closely matched to the shape of the neck zone of the ampoule by heating. The sleeve is for instance made from an elastomer and is configured to protect the user when breaking the head of said ampoule vial. The sleeve requires to be mounted on the neck of the ampoule and then the ampoule provided with its elastomer sleeve must be packaged in a conventional packaging such as a box, in particular a cardboard box or a plastic box.

The invention is directed to a packaging for container such as an ampoule vial, which is safe to manipulate, simple, compact and economic.

### SUMMARY OF THE INVENTION

The invention accordingly provides a packaging for a container filled with a liquid pharmaceutical product and comprising a head and a body both made from a single piece and a neck portion configured to form a frangible junction between said head and said body, said packaging being made from plastic material and comprising two layers between which are defined a cavity configured to receive said container; wherein said packaging is a unitary packaging which is configured to receive one container and comprises a foldable portion configured so that an upper portion of said packaging which is configured to receive said head of said container folds when said head is submitted to a determined strength, an access portion provided at least around a part of said upper portion and being remote to said foldable portion and a protective portion configured between said access portion and said foldable portion; so that when said head of said container is broken due to said determined strength, said foldable portion is configured to be folded, said access portion is configured to give free access to said liquid pharmaceutical product in said body and said protective portion is configured to protect the access to the broken neck portion of said container.

In other words, the packaging according to the invention is a unitary packaging, like a blister, for only one container of the ampoule vial type, which unitary packaging is formed by a shell that surrounds said ampoule vial. The shell is configured to protect as a cover the ampoule vial type.

The unitary packaging is easily transportable and storable, easy to handle and safer than the known container of the ampoule vial type mentioned above.

Thanks to the invention, a user (also named a patient) which would open the container must open both the unitary packaging and the container at the same time by pushing the head of the container relatively to the body of the container. The head of the container and the upper portion of the packaging are thus both submitted to the determined strength, next the upper portion folds and the frangible junction breaks until the head leaves the neck portion and the body.

The user will not get hurt because the sharp edges provided to the frangible junction, due to its break, are covered by the protective portion of the unitary packaging.

According to features preferred as being very simple, convenient and economical for embodying the packaging according to the invention:
the packaging comprises at least one notch configured in the vicinity of said foldable portion;
the packaging comprises a frame formed by said two layers, which frame defines a peripheral edge and said at least one notch is provided in said frame, on said peripheral edge or remote to said peripheral edge;
said access portion access portion is formed by a cut-out provided in said two layers;
said cavity extends longitudinally extends according to a shape of said container and said cut-out transversally extends in said frame, close and along to said protective portion, and said at least one notch projects from said cut-out and extends towards and into said protective portion until reaching said foldable portion;
said two layers are made from a single molded sheet of plastic material, said sheet being configured to be folded to form said cavity and welded to form a sealed outline;
the packaging comprises at least one finger print portion configured to grasp said head of said container;
said at least one at least one finger print portion is formed by a recess provided in said upper portion of said packaging;
said cavity comprises a first area configured to receive said body of said container, said first area having a height similar to a height of said body, and a second area configured to receive said head of said container, said second area having a height bigger than a height of said head; so that when said head is broken due to said determined strength, said head moves towards a bottom of said second area; and/or
the packaging comprises at least one retention rib provided in a lower portion of said packaging where said body of said container is configured to be received.

The invention further provides a unitary assembly comprising a packaging unit as described above and a container filled with a liquid pharmaceutical product and comprising a head and a body both made from a single piece and a neck portion configured to form a frangible junction between said head and said body, said container being introduced in said cavity of said packaging unit.

The unitary assembly according to the invention is safe to manipulate, simple, compact and economic.

According to features preferred as being very simple, convenient and economical for embodying the unitary assembly according to the invention, said container is of the ampoule vial type made from glass.

The invention further provides a method for assembling a unitary assembly as described above, comprising the following steps:
providing a unitary packaging made from plastic material and comprising two layers in an unfoldable state, each layer defining a half cavity and comprising a foldable portion, an access portion provided at least around an upper portion of said unitary packaging and remote to said foldable portion and a protective portion configured between said access portion and said foldable portion;
providing a container filled with a liquid pharmaceutical product and comprising a head and a body both made from a single piece and a neck portion configured to form a frangible junction between said head and said body;
mounting said container into said half cavity of any one of said two layers of said unitary packaging;
facing said two layers of said unitary packaging by folding them against each other so that said foldable portion of said unitary packaging is located at the level of said frangible junction of said container, said access portion of said unitary packaging is located at least around said upper portion of said unitary packaging where said head of said container is received and said protective portion of said unitary packaging is located in the vicinity of said neck portion of said container, between said head and said frangible junction of said container;
fixing said two layers which face.

The method according to the invention is simple and safe to carry out.

According to features preferred as being very simple, convenient and economical for embodying the method according to the invention, said step of fixing said two layers is made by welding.

### BRIEF DESCRIPTION OF THE DRAWINGS

The description of the invention now continues with a detailed description of a preferred embodiment given hereinafter by way of non-limiting example and with reference to the appended drawings. In these drawings:

FIG. 1 is a perspective view of a unitary assembly in a close state, comprising a packaging unit and a container of the ampoule vial type, the container being introduced in said packaging unit;

FIG. 2 is a perspective view of the unitary assembly shown in FIG. 1 in an opened state;

FIGS. 3 and 4 are schematic views of the packaging unit shown on FIG. 1 in an unfolded state, showing respectively an external face and an internal face of said packaging unit; and

FIG. 5 is a perspective view of the container shown on FIG. 1.

### DETAILED DESCRIPTION OF PREFERRED EMBODIMENTS

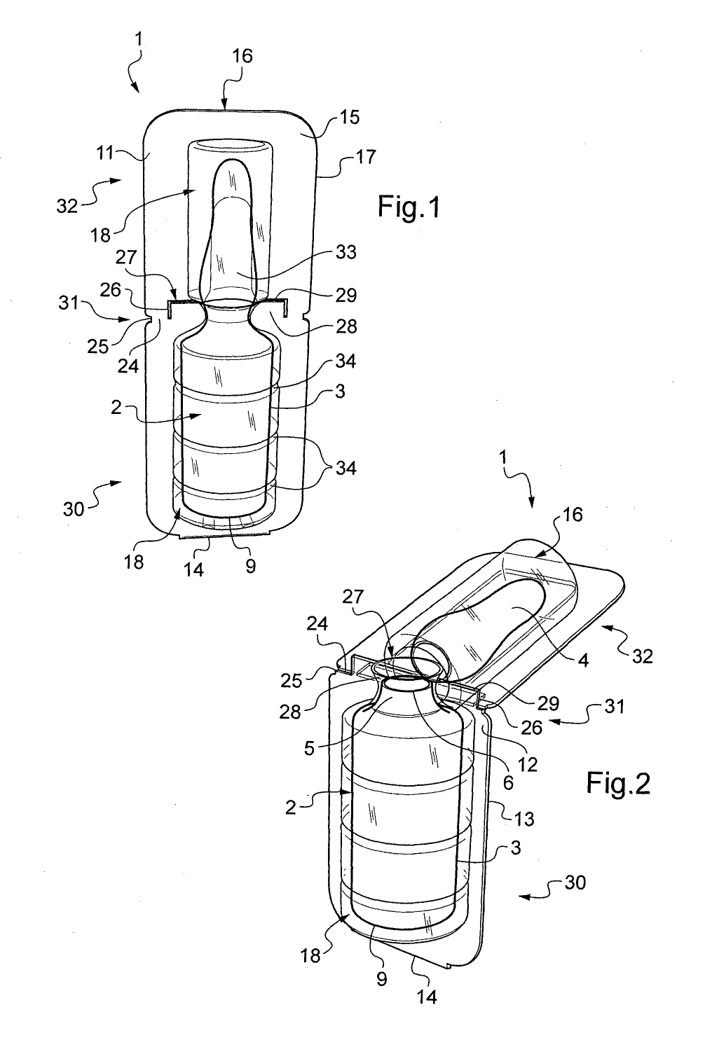

FIG. 1 shows a unitary assembly 1 comprising a container 2 and a packaging unit 11, also named blister, in which is received the container 2.

We will describe the container 2 with respect to FIGS. 1 and 5.

The container is an ampoule vial 2 made from a single piece of glass and is filled with a liquid pharmaceutical product.

The ampoule vial 2 comprises a body 3 which has a general tubular shape, a head 4 which has a general flared shape and a neck portion 5 which has a general cylindrical shape and which is located between the head 4 and the body 3 (FIG. 5).

The ampoule vial 2 comprises a first shoulder 7 linking the body 3 and the neck portion 5 and a second shoulder 8 linking the neck portion 5 and the head 4.

The body 3 has a first determined volume accordingly to a first determined height and comprises a flat bottom portion 9.

The first determined volume of the body 3 allows the body 3 to receive a full determined volume of liquid pharmaceutical product.

The head 4 has a second determined volume accordingly to a second determined height and comprises a free end 10 which is round.

The ampoule vial 2 is configured so that when the ampoule vial 2 is in a vertical state (in other words standing), only the body 3 is filled with the liquid pharmaceutical product and when the ampoule vial 2 is in a horizontal state (in other words lying), the head 4 and the neck portion 5 and the body 3 comprise such a liquid.

The neck portion 5 has in section the smallest diameter.

The neck portion 5 is configured to form a frangible junction 6 between the head 4 and the body 3.

The frangible junction 6 is generally marked by a pre-breaking line (not represented).

The pre-breaking line is provided to facilitate the opening of the ampoule vial 2 in order to have access to the liquid pharmaceutical product. For opening the ampoule vial 2, a user, also named a patient, has to submit the head 4 to a determined strength relatively to the body 3 so that the head 4 is released from the ampoule vial 2, in particular from the neck portion 5.

We will now describe the packaging unit 11 with respect to FIGS. 1, 3 and 4.

The packaging unit 11 is made from a single molded sheet of plastic material.

The packaging unit 11 comprises two layers 12, 13 and a fold 14 linking the two layers 12, 13 and made together from the single molded sheet of plastic material.

The two layers 12, 13 are similar and symmetric relative to an axis of symmetry through the fold 14.

The fold 14 defines the bottom of the packaging unit 11, according to the orientation of FIG. 1 showing the packaging unit 11 and the ampoule vial 2 in a vertical state, in other words standing.

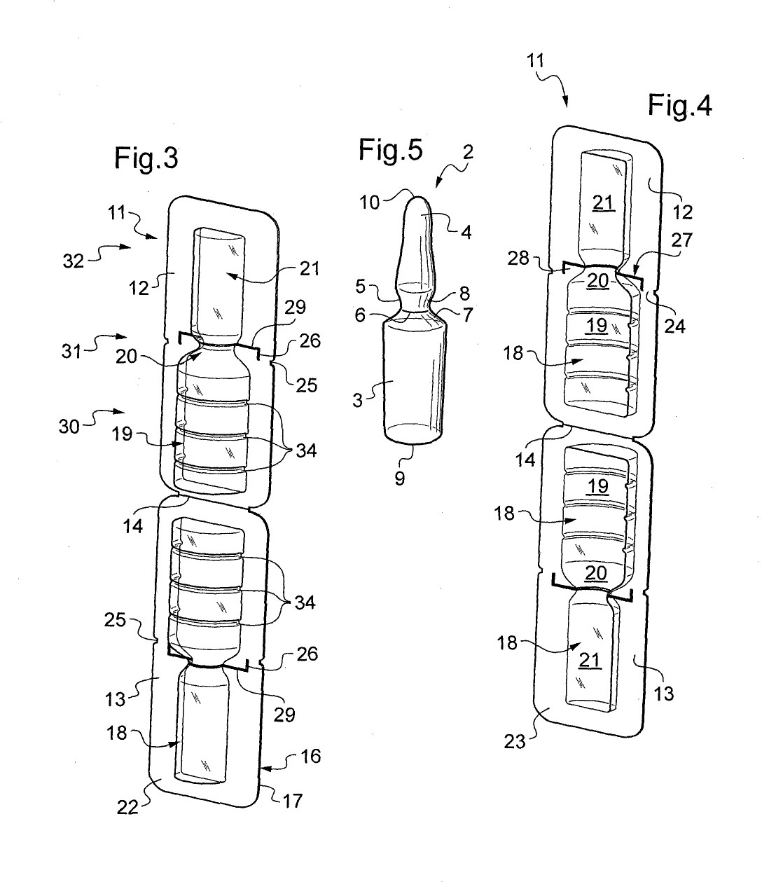

Each layer 12, 13 forms a frame 15 having an outline 16 defining a peripheral edge 17 and having an external face 22 shown on FIG. 3 and an internal face 23 shown on FIG. 4.

Each layer 12, 13 comprises a half cavity 18 provided in the frame 15 and having a first half area 19 provided in a lower portion 30 of the frame 15, a second half area 21 provided in an upper portion 32 of the frame 15 and a third half area 20 provided in a middle portion 31 of the frame 15.

Thus, the single molded sheet of plastic material is configured to be folded to form a cavity 18 and welded to form the sealed outline 16.

The half cavity 18 generally extends longitudinally.

The half cavity 18 has a general shape similar to the half shape of the ampoule vial 2.

The first half area 19 is configured to partially receive the body 3, the second half area 21 is configured to partially receive the head 4 and the third half area 20 is configured to partially receive the neck portion 5.

The second half area 21 has a height taken along the longitudinally direction which is bigger than the second determined height of the head 4 while the first half area 19 has a height also taken along the longitudinally direction which is similar to the first determined height of the body 3.

The half cavity 18 protrudes from the external face 22 of the frame 15 (FIG. 3) while the half cavity 18 is formed into the internal face 23 of the frame 15, like a recess.

Each layer 12, 13 comprises a foldable portion 24 in the vicinity of the second half area 20.

Each layer 12, 13 comprises two first notches 25 each being provided in the frame 15, opening at the peripheral edge 17 on opposite sides of the frame 15 and located close to the foldable portion 24.

Each layer 12, 13 also comprises two second notches 26 each being provided in the frame 15, remote to the peripheral edge 17 and located close to the foldable portion 24, opposite to a respective first notch 25.

Each foldable portion 24 thus comprises two parts respectively formed between a first notch 25 and a second notch 26.

Each layer 12, 13 further comprises an access portion 27 provided in the frame 15, at least around the third half area 21, and which is located remote to the foldable portion 24.

Each layer 12, 13 further comprises a protective portion 28 provided in the frame 15 and configured between the access portion 27 and the foldable portion 24.

Each layer 12, 13 comprises a cut-out 29 provided in the frame 15 and forming the access portion 27.

The cut-out 29 transversally extends in the frame 15, close and along the protective portion 28.

The two second notches 26 of each layers 12, 13 project from the cut-out 29 and each extends towards and into the protective portion 28 until reaching the foldable portion 24.

Each layer 12, 13 further comprises a finger print portion 33 provided in the upper portion 31 of the frame 15.

The finger print portion 33 is formed by a longitudinal recess provided in the external face 22 (and thus a longitudinal projection provided in the internal face 23) at the level of the second half area 21.

The finger print portion 33 is configured to grasp the head 4 of the ampoule vial 2.

Each layer 12, 13 further comprises a plurality of retention ribs 34 provided in the lower portion 30 of the frame 15.

The retention ribs 34 are formed by transversal recesses provided in the external face 22 (and thus transversal projections provided in the internal face 23) at the level of the first half area 19.

We will now describe a method for assembling the unitary assembly 1.

The first step of the method for assembling the unitary assembly 1 is to provide a unitary packaging 11 as described above, in an unfoldable state as shown in FIGS. 3 and 4.

Next, the second step is to provide the ampoule vial 2 as described above with respect to FIG. 5.

Next, the ampoule vial 2 is mounted into the half cavity 18 of any one of the two layers 12, 13 of the unitary packaging 11, the body 3 being introduced into the first half area 19, the neck portion 5 being introduced into the third half area 20 ant the head 4 being introduced into the second half area 21.

Next, the two layers 12, 13 are folded about the fold 14 so that the layer 12 faces the layer 13 until the internal face 23 of the layer 12 comes into abutment against the internal face 23 of the layer 13.

The ampoule vial 2 is thus mounted into the half cavity 18 of the other of the two layers 12, 13 of the unitary packaging 11, the first half area 19 covering the body 3, the third half area 20 covering the neck portion 5 ant the second half area 21 covering the head 4.

In the foldable state of the unitary packaging 11, the ampoule vial 2 is thus introduced in the cavity 18 formed by the layers 12 and 13, the foldable portion 24 of the unitary packaging 11 is located at the level of the frangible junction 6 of the ampoule vial 2, the access portion 27 of the unitary packaging 11 is located at least around the upper portion 32 of the unitary packaging 11 where the head 4 of the ampoule vial 2 is received and the protective portion 28 of the unitary packaging 111 is located in the vicinity of the neck portion 5 of the ampoule vial 2, between the head 4 and the frangible junction 6 of the ampoule vial 2.

Next, the two layers 12 and 13 are fixed together at their peripheral edges 17 by welding so that the outline 16 of the unitary packaging 11 is sealed. Thus, the unitary packaging 11 is sealed, the portion of the respective internal surface of each layer 12, 13 in the vicinity of the outline 16 being heated thanks to a thermic step automatically carrying out, so that the heated portions of the layers 12, 13 are welded one against each other to form this outline 16.

The method for assembling the unitary assembly 1 is thus very simple to carry out.

In this fixing state, the ampoule vial 2 can not move in the cavity 18.

The ampoule vial 2 is thus protected by the packaging 11 which is here used like a blister.

We will now describe a method for safely opening the unitary assembly 1.

A user (also named a patient) which would open the unitary assembly 1 must open both the unitary packaging 11 and the ampoule vial 2 at the same time by pushing the head 4 of the ampoule vial 2 relatively to the body 3 of the ampoule vial 2.

The user grasps the unitary assembly 1 by handling the finger prints 34 with two fingers (one finger on each finger print 34) and acts on the head 4 of the ampoule vial 2 with a determined strength.

The foldable portion 24 folds thanks to the weak made from the notches 25 and 26.

The head 4 of the ampoule vial 2 and the upper portion 32 of the packaging 11 are thus both submitted to the determined strength.

The upper portion 32 of the frame 15 folds thanks to the access portion 27 and the frangible junction 6 breaks until the head 4 leaves the neck portion 5 and the body 3.

In the same time, the access portion 27 gives free access to the liquid pharmaceutical product in the body 3 of the ampoule vial 2 thanks to the cut-out 29; and the protective portion 28 protects the access to the broken neck portion 5 of the ampoule vial 2.

The user will not get hurt because the sharp edges provided to the frangible junction 6, due to its break, are covered by the protective portion 28 of the unitary packaging 11.

The method for opening the unitary assembly 1 is very simple and safe to carry out.

In variants that are not illustrated:
the unitary assembly can be clustered with other similar unitary assemblies; the packaging of these unitary assemblies are joined together, each unitary assembly being joined to two other unitary assemblies except the unitary assemblies which are located at a free end;
the packaging does not comprise two layers made from a single sheet but rather two distinct layers;
the packaging comprises more or less notches and these notches can differently be configured on the frame;
the packaging can comprise more than one cut-out and the cut-out can differently be configured on the frame;
the body does not comprise a bottom portion which is flat, but rather the bottom portion is rounded; and/or
the unitary packaging 11 is not sealed thanks to a thermic step automatically carrying out, but the portions of the internal surfaces of each layer 12, 13 in the vicinity of the outline respectively comprise projections and complementary recesses, and the unitary packaging 11″ is sealed manually or automatically when folding the layers, until the projections are introduced into the recesses.

It should be noted more generally that the invention is not limited to the examples described and represented.

1. Packaging for a container (2) filled with a liquid pharmaceutical product and comprising a head (4) and a body (3) both made from a single piece and a neck portion (5) configured to form a frangible junction (6) between said head (4) and said body (3), said packaging (11) being made from plastic material and comprising two layers (12, 3) between which are defined a cavity (18) configured to receive said container (2); wherein said packaging (11) is a unitary packaging which is configured to receive one container (2) and comprises a foldable portion (24) configured so that an upper portion (32) of said packaging (1) which is configured to receive said head (4) of said container (2) folds when said head (4) is submitted to a determined strength, an access portion (27) provided at least around a part of said upper portion (32) and being remote to said foldable portion (24) and a protective portion (28) configured between said access portion (27) and said foldable portion (24); so that when said head (4) of said container (2) is broken due to said determined strength, said foldable portion (24) is configured to be folded, said access portion (27) is configured to give free access to said liquid pharmaceutical product in said body (3) and said protective portion (28) is configured to protect the access to the broken neck portion (5) of said container (2).

2. Packaging according to claim 1, wherein it comprises at least one notch (25, 26) configured in the vicinity of said foldable portion (24).

3. Packaging according to claim 2, wherein it comprises a frame (15) formed by said two layers (12, 13), which frame (15) defines a peripheral edge (17) and said at least one notch (25, 26) is provided in said frame (15), on said peripheral edge (17) or remote to said peripheral edge (17).

4. Packaging according to claim 1, wherein said access portion (24) is formed by a cut-out (29) provided in said two layers (12, 13).

5. Packaging according to claim 3, wherein said cavity (18) longitudinally extends according to a shape of said container (2) and said cut-out (29) transversally extends in said frame (15), close and along to said protective portion (28), and said at least one notch (26) projects from said cutout (29) and extends towards and into said protective portion (28) until reaching said foldable portion (24).

6. Packaging according to claim 1, wherein said two layers (12, 13) are made from a single molded sheet of plastic material, said sheet being configured to be folded to form said cavity (18) and welded to form a sealed outline (16).

7. Packaging according to claim 1, wherein it comprises at least one finger print portion (33) configured to grasp said head (4) of said container (2).

8. Packaging according to claim 7, wherein said at least one finger print portion (33) is formed by a recess provided in said upper portion (32) of said packaging (11).

9. Packaging according to claim 1, wherein said cavity (18) comprises a first area (19) configured to receive said body of said container, said first area (19) having a height similar to a height of said body (3), and a second area (21) configured to receive said head (4) of said container (2), said second area (21) having a height bigger than a height of said head (4); so that when said head (4) is broken due to said determined strength, said head (4) moves towards a bottom of said second area (21).

10. Packaging according to claim 1, wherein it comprises at least one retention rib (34) provided in a lower portion (30) of said packaging (11) where said body (3) of said container (2) is configured to be received.

11. Unitary assembly comprising a packaging unit (11) according to claim 1 and a container (2) filled with a liquid pharmaceutical product and comprising a head (4) and a body (3) both made from a single piece and a neck portion (5) configured to form a frangible junction (6) between said head (4) and said body (3), said container (2) being introduced in said cavity (18) of said packaging unit (11).

12. Unitary assembly according to claim 11, wherein said container (2) is of the ampoule vial type made from glass.

13. Method for assembling a unitary assembly (1) according to claim 1, comprising the following steps:
providing a unitary packaging (11) made from plastic material and comprising two layers (12, 13) in an unfoldable state, each layer (12, 13) defining a half cavity (18) and comprising a foldable portion (24), an access portion (27) provided at least around an upper portion (32) of said unitary packaging (11) and remote to said foldable portion (24) and a protective portion (28) configured between said access portion (27) and said foldable portion (24);
providing a container (2) filled with a liquid pharmaceutical product and comprising a head (4) and a body (3) both made from a single piece and a neck portion (5) configured to form a frangible junction (6) between said head (4) and said body (3);
mounting said container (2) into said half cavity (18) of any one of said two layers (12, 13) of said unitary packaging (1);
facing said two layers (12, 13) of said unitary packaging (11) by folding them against each other so that said foldable portion (24) of said unitary packaging (11) is located at the level of said frangible junction (6) of said container (2), said access portion (27) of said unitary packaging (11) is located at least around said upper portion (32) of said unitary packaging (11) where said head (4) of said container (2) is received and said protective portion (28) of said unitary packaging (11) is located in the vicinity of said neck portion (5) of said container (2), between said head (4) and said frangible junction (6) of said container (2);
fixing said two layers (12, 13) which face.

14. Method according to claim 13, wherein said step of fixing said two layers (12, 13) is made by welding.
